(19) United States
(12) Patent Application Publication
(10) Pub. No.: US 2003/0074260 A1
(43) Pub. Date: Apr. 17, 2003

(54) Image displaying method and point card

(76) Inventors: Nobuyoshi Sugiyama, Numadu-shi (JP); Yoshihiko Hotta, Mishima-shi (JP); Kazumi Suzuki, Suntou-gun (JP); Hideji Tanaka, Numadu-shi (JP); Hiroyuki Sugimoto, Kawasaki-shi (JP); Shigeaki Nimura, Chiba-shi (JP); Shigenobu Hirano, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/269,069

(22) Filed: Oct. 11, 2002

(30) Foreign Application Priority Data
Oct. 12, 2001 (JP) P2001-314735

(51) Int. Cl. G06F 17/60

(52) U.S. Cl. 705/14

(57) ABSTRACT

A reversible thermosensitive recording medium comprising an concealing layer provided between a reversible thermosensitive recording layer which is reversibly changed in its color by heat and a photo-thermal conversion layer which absorbs light with generating heat, wherein the concealing layer has an optical characteristic that the ratio of a light absorptivity of light having 555 nm wavelength, in comparison with a light absorptivity of laser light wavelength, is 80% or less. This reversible thermosensitive recording medium has a concealing layer to conceal the color of the photo-thermal conversion layer, thereby the visibility and the contrast of the obtained images are significantly improved, further more, durability in repeated used is also significantly improved.

### BACKGROUND OF THE INVENTION

1. Field of the Invention

The present invention relates to an image displaying method and a point card, and more specifically, relates to an image displaying method and a point card which are capable of presenting a premium point to be exchanged to a corresponding premium feature to the customer, and as for the customer side, the method and the point card are ones capable of making known an adequate opportunity for getting premium feature such as daily necessities goods, therefore they do not make lose or make forget the opportunity to exchange to the real premium feature, and thereby apt to make rouse the eager buying intention.

2. Description of the Related Art

Heretofore, there has been a business custom to present a premium to customers in accordance to the number of merchandise times or to the volume of business, for the purposes of customer-acquisition and of purveying service. For the such purposes, there hitherto have been issued gold certificates to be used to discount the price of commodity or have been issued servicing ticket or point ticket such as blue tip which are collected to a predetermined amount to be exchanged to the required goods or to make discount the price of commodity purchased. Otherwise, labels or seal papers having been presented to customers which were mounted to the supporting paper or stamped marks were imprinted to the supporting paper in accordance to the number of merchandise times or to the volume of business, and they were used in the same manner as aforementioned one.

However, in general such manners having been carried out conventionally are ones using small tips of paper, therefore are annoyingness for calculating acquired points and are the hazard of frequently lost or forgot. And more, the manners of sticking of the small papers or stamping marks are inevitably required to employ supporting papers which ordinary have large extent area thus are not able to be compacted dealing with in for example shopping, showing difficulty in the use. Further, their use times are limited with in the width of the supporting paper, and when the supporting papers are filled with pasted small papers or stamped marks, the supporting papers are not used any more, thus scrapped, and re-issue of new one is required.

As a method for dissolving such drawbacks, there is a proposed one in Japanese Unexamined Patent Publication of Tokkai Hei 4-358896 which concerns with a rewriting type point card using a rewritable recording material. This point card is one for updating or in other words, erasing the information of accumulated values such as points until last occasion of use and displaying information of revised value such as points, the number of merchandise times or the volume of business which are caused by a result of acquisition or lost at the instance occasion. This card can evade the aforementioned drawbacks pursuant to aforementioned manners, however the display is mono-chrome, hence is not outstanding. Thus problem thereof is there in the nature being likely to overlook the display for showing the state whether predetermined points or amount of money have been attained or not yet, in case that a deep attention is not paid to the displayed characters such as figures.

### SUMMARY OF THE INVENTION

It is hence an object of the present invention is, in view of the situation of above descried prior arts, to solve such drawbacks and problems pursuant to conventional arts, and to provide an image-displaying method and a point card which are capable of presenting a premium point to be exchanged to a corresponding premium feature to the customer, and as for the customer side, the method and the point card are ones capable of making known an adequate opportunity for getting premium feature such as daily necessities goods, therefore they do not make lose or make forget the opportunity to exchange to the real premium feature, and thereby are apt to make rouse the eager buying intention, with diminishing undesirable states such as overlooking of opportunity to exchange to a real worth.

Above and other objects of the present invention are achieved by an image-displaying method which comprising:

(1) A method for displaying images onto a point card used for presenting a premium point to be exchanged to a corresponding premium feature to the customer in accordance to sales number of times, sales amount or sales volume, wherein the method uses the card which has a reversible color-recording medium at least a part therein, and the recording medium is capable of forming and erasing images of at least one color in a plural of colors upon energy impose, and capable of keeping the displayed images colors as far as no energy is again imposed thereon, and when the accumulated points being displayed on the card come up to or exceed a previously determined numerical worth value, at least one color of at least one image in displayed images or a color of background area thereof is changed;

(2) A method for displaying images onto a point card used for presenting a premium point to be exchanged to a corresponding premium feature to the customer in accordance to sales number of times, sales amount or sales volume, wherein the method uses the card which has a reversible color-recording medium at least a part therein and a memory for information storage, and the recording medium is capable of forming and erasing images of a plural of colors upon energy impose, and capable of keeping the displayed images colors as far as no energy is again imposed thereon, and when the accumulated points being displayed on the card come up to or exceed a previously determined numerical worth value, at least one color of at least one image in displayed images or a color of background area thereof is changed and at the same time the stored information in the memory is updated as acquired or spent by the customer;

(3) The method for displaying images according to above paragraphs (1), wherein above described at least one color of at least one image in displayed images or one color of background area thereof is also changed when a predetermined valid term of the card is expired or a designated valid time of period is passed;

(4) The method for displaying images according to above paragraphs (1), wherein above described at least one color of at least one image in displayed images or one color of background area thereof is also changed when identification data of the card owner does not concord with input data for verification;

Above and other objects of the present invention are still achieved by a point card which comprising:

(5) A point card used for presenting a premium point to be exchanged to a corresponding premium feature to the customer in accordance to sales number of times, sales. amount or sales volume, wherein the card has a reversible color-recording medium at least a part therein, and the recording medium is capable of forming and erasing images of a plural of colors upon energy impose, and capable of keeping the displayed images colors as far as no energy is again imposed thereon, and when the accumulated point being displayed on the card come up to or exceed a previously determined numerical worth value, at least one color of at least one image in displayed images or a color of background area thereof is changed;

(6) A point card used for presenting a premium point to be exchanged to a corresponding premium feature to the customer in accordance to sales number of times, sales amount or sales volume, wherein the card has a reversible color-recording medium at least a part therein and a memory for information storage, and the recording medium is capable of forming and erasing images of a plural of colors upon energy impose, and capable of keeping the displayed images colors as far as no energy is again imposed thereon, and when the accumulated point being displayed on the card come up to or exceed a previously determined numerical worth value, at least one color of at least one image in displayed images or a color of background area thereof is changed and at the same time the stored information in the memory is updated as acquired or spent by the customer;

(7) The point card according to above paragraphs (5), wherein above described at least one color of at least one image in displayed images or one color of background area thereof is also changed when a predetermined valid term of the card is expired or a designated valid time of period is passed;

(8) The point card according to above paragraphs (5), wherein above descried at least one color of at least one image in displayed images or one color of background area thereof is also changed when identification data for card owner does not concord with input data for verification.

Above and other objects of the present invention are also achieved by an apparatus for treating a point card which comprising:

(9) An apparatus for treating a point card used for presenting a premium point to be exchanged to a corresponding premium feature to the customer in accordance to sales number of times, sales amount or sales volume, wherein the apparatus records and erases images on the card which has a reversible color-recording medium in at least a part therein, and the recording medium is one capable of forming and erasing at least one color image in a plural of color images upon energy impose and capable of keeping the displayed images colors as far as no energy is again imposed thereon, and the apparatus comprises a read-in means of management data which is time series ones concerned with history of the card, an energy-imposing means for imposing a thermal or optical energy onto the recording medium, a drive control means for controlling the driving state of the energy-imposing means, a power supply-controlling circuit for controlling the electrifying state supplied to the energy-imposing means, and the drive control means and the power supply-controlling circuit are controlled by input signals which are issued depending on an information for management;

(10) An apparatus for treating a point card for presenting a premium point to be exchanged to a corresponding premium feature to the customer in accordance to sales number of times, sales amount or sales volume, wherein the apparatus records and erases images on the card which has a reversible color-recording medium in at least a part therein, and the recording medium is one capable of forming and erasing images of a plural of colors upon energy impose and capable of keeping the displayed images colors as far as no energy is again imposed thereon, and the apparatus comprises a management data-updating means for updating the management data which is time series ones concerned with history of the card and being stored in an information memory unit, an energy-imposing means for imposing a thermal or optical energy onto the recording medium, a drive control means for controlling the driving state of the energy-imposing means, a power supply-controlling circuit for controlling the electrifying state supplied to the energy-imposing means, and the drive control means and the power supply-controlling circuit are controlled by input signals which are issued depending on the management data;

(11) The apparatus for treating a point card according to above paragraphs (9), wherein the energy-imposing means is a thermal energy-imposing means which is capable of both recording the reversible new color images and erasing the existed reversible color images;

(12) The apparatus for treating a point card according to above paragraph (11), wherein the thermal energy-imposing means is a thermal head;

(13) The apparatus for treating a point card according to above paragraph (11), wherein the thermal energy-imposing means is a thermal head and a heat roller which is positioned in front of the thermal head, and conducts the erasure of the reversible color images which being existed in the point card;

(14) The apparatus for treating a point card according to above paragraphs (9) or (10), wherein the information for management is an image information to be recorded in an image-forming material which comprises a leuco dye and a color-developer having long chain alkyl group;

(15) The apparatus for treating a point card according to above paragraphs (9) or (10), wherein the information for management is a light-reflective image information to be recorded in an image-forming material which comprises a middle-molecular-weight liquid crystal material;

(16) The apparatus for treating a point card according to above paragraphs (9) or (10), wherein the information for management is one provided on a transparent substrate;

(17) The apparatus for treating a point card according to above paragraph (12), wherein the apparatus is one having a photo-sensor to read-in an image information.

(18) The apparatus for treating a point card according to above paragraphs (9) or (10), wherein the apparatus is one having a first memory for storing the information for management in a mode capable of invocation, a second memory for storing in advance a standard information for management and a CPU, and it can conduct calculations including comparisons of the information for management with the standard information for management.

(19) The apparatus for treating a point card according to above paragraph (18), wherein the apparatus is one having a faculty to reinput a result of the calculations by the CPU into the first memory in a mode capable of invocation, to update said information for management;

(20) The apparatus for treating a point card according to above paragraph (12), wherein the apparatus is one having a transportation means of the image recording medium for transporting the medium to the thermal head and to the outside of the apparatus, a driver for driving the transportation means, and a controller for the driver;

(21) The apparatus for treating a point card according to above paragraphs (18) or (19), wherein said CPU is one having at least two or more input-output ports which are ones for inputting and outputting information signals from and to two or more means among the photo-sensor, the first memory and the second memory, the controller for the driver for driving the transportation means, the power supply-controlling circuit and the thermal head drive-controlling means, and having a third memory which stores a sequence program to decide sequential order for inputting from and outputting to said means with said information signals;

(22) The apparatus for treating a point card according to above paragraphs (9) or (10), wherein said information to be managed is an inspection result of medical examination, and said information data for management contains normal value data, outlier value data, caution value data, and colors of demonstrated information to be managed are differed according to said three value data;

(23) The apparatus for treating a point card according to above paragraphs (9) or (10), wherein said information to be managed and/or said information for management include data showing time of period or data showing limit date.

### BRIEF DESCRIPTION OF THE DRAWINGS

FIG. 1 is a view showing an example of a point card of the present invention.

FIG. 2 is a flow chart showing an example in which an image-displaying method of the present invention is demonstrated.

FIG. 3 is a flow chart showing an example in which another image-displaying method of the present invention is demonstrated.

FIG. 4 is a flow chart showing an example in which still another image-displaying method of the present invention is demonstrated.

FIG. 5 is a view showing a cross sectional example of a point card of the present invention.

FIG. 6 is a diagram showing a phase change model of a cholesteric liquid crystal compound material used in the point card of the present invention.

FIG. 7 is a structural formula showing a cholesteric liquid crystal compound having a middle molecular weight which is used in the point card of the present invention.

FIG. 8 is a structural formula showing another cholesteric liquid crystal compound having a middle molecular weight which is used in the point card of the present invention.

FIG. 9 is a view showing a cross sectional example of another point card of the present invention using reversible heat-sensitive recording material.

FIG. 10 is a view showing an example of a point card used in an image-displaying method of the present invention.

FIG. 11 is a view showing an example of another point card used in another image-displaying method of the present invention.

FIG. 12 is a view showing an example of still another point card used in still another image-displaying method of the present invention.

FIG. 13 is a view showing an example of more another point card used in more another image-displaying method of the present invention.

FIG. 14 is a view showing an example of furthermore another point card used in furthermore another image-displaying method of the present invention.

FIG. 15 is a view showing a conceptual Example of an apparatus for treating a point card of the present invention.

FIG. 16 is a view showing the conception of another apparatus for treating a point card of the present invention.

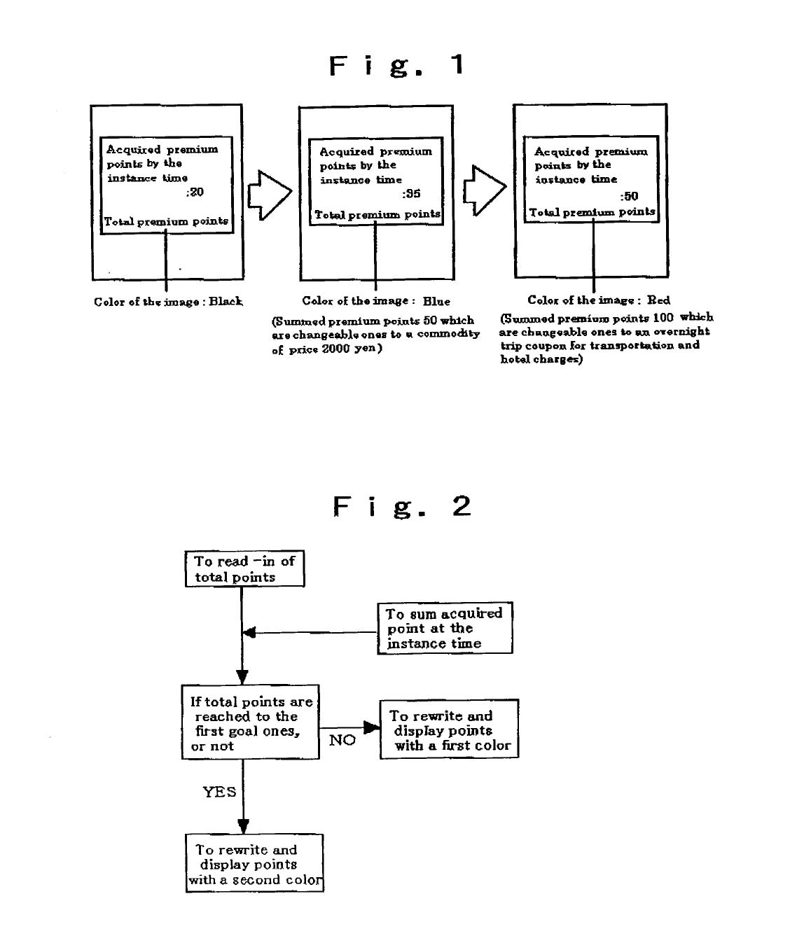

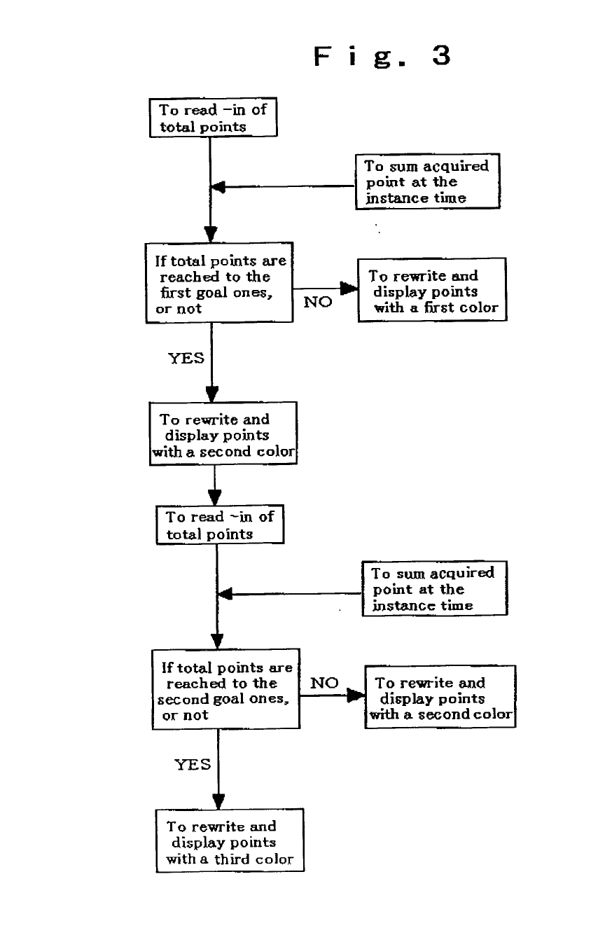

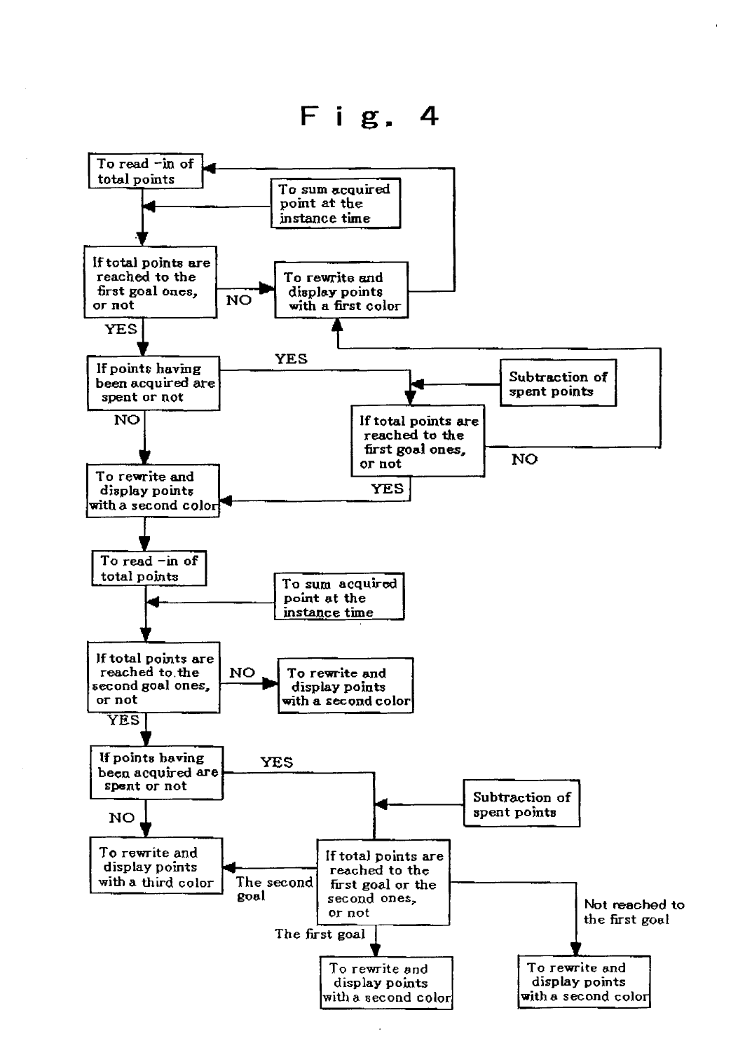

### DESCRIPTION OF THE PREFERRED EMBODIMENTS

Inventors of the present invention have studied for overcoming the foregoing drawbacks and problems, and discovered that the problems are solved by using a card which has a reversible color-recording medium, and the recording medium is capable of forming and erasing images of at least one color in a plural of colors upon energy impose, and capable of keeping the displayed images colors as far as no energy is again imposed thereon, and when the accumulated points being displayed on the card comes up to or exceed a previously determined numerical worth value, at least one color of at least one image in displayed images or a color of background area thereof is made change.

Namely, first of all, according to the present invention, there is provided an image-displaying method for displaying images onto a point card used for presenting a premium point to be exchanged to a corresponding premium feature to the customer in accordance to sales number of times, sales amount or sales volume, wherein the method uses the card which has a reversible color-recording medium at least a part therein, and the recording medium is capable of forming and erasing images of at least one color in a plural of colors upon energy impose, and capable of keeping the displayed images colors as far as no energy is again imposed thereon, and when the accumulated points being displayed on the card comes up to or exceed a previously determined numerical worth value, at least one color of at least one image in displayed images or a color of background area thereof is changed.

At second, according to the present invention, there is provided another image-displaying method for displaying images onto a point card used for presenting a premium point to be exchanged to a corresponding premium feature to the customer in accordance to sales number of times, sales amount or sales volume, wherein the method uses the card which has a reversible color-recording medium at least a part therein and a memory for information storage, and the recording medium is capable of forming and erasing images of at least one color of a plural of colors upon energy impose, and capable of keeping the displayed images colors as far as no energy is again imposed thereon, and when the accumulated point being displayed on the card comes up to or exceeds a previously determined numerical worth value, at least one color of at least one image in displayed images or a color of background area thereof is changed and at the same time the stored information in the memory is updated as acquired or spent by the customer.

At third, according to the present invention, there is provided a point card used for presenting a premium point to be exchanged to a corresponding premium feature to the customer in accordance to sales number of times, sales amount or sales volume, wherein the card has a reversible color-recording medium at least a part therein, and the recording medium is capable of forming and erasing images of at least one color in a plural of colors upon energy impose, and capable of keeping the displayed images colors as far as no energy is again imposed thereon, and when the accumulated point being displayed on the card comes up to or exceeds a previously determined numerical worth value, at least one color of at least one image in displayed images or a color of background area thereof is changed.

At forth, according to the present invention, there is provided another point card used for presenting a premium point to be exchanged to a corresponding premium feature to the customer in accordance to sales number of times, sales amount or sales volume, wherein the card has a reversible color-recording medium at least a part therein and a memory for information storage, and the recording medium is capable of forming and erasing images of at least one color in a plural of colors upon energy impose, and capable of keeping the displayed images colors as far as no energy is again imposed thereon, and when the accumulated point being displayed on the card comes up to or exceeds a previously determined numerical worth value, at least one color of at least one image in displayed images or a color of background area thereof is changed and at the same time the stored information in the memory is updated as acquired or spent by the customer.

As already mentioned above, the present invention provides at first an image-displaying method for displaying images onto a point card used for presenting a premium point to be exchanged to a corresponding premium feature to the customer in accordance to sales number of times, sales amount or sales volume, wherein the method uses the card which has a reversible color-recording medium at least a part therein, and the recording medium is capable of forming and erasing images of at least one color in a plural of colors upon energy impose, and capable of keeping the displayed images colors as far as no energy is again imposed thereon, and when the accumulated points being displayed on the card comes up to or exceed a previously determined numerical worth value, at least one color of at least one image in displayed images or a color of background area thereof is changed.

Hereupon, examples of “the recording medium capable of forming and erasing images of at least one color in a plural of colors upon energy impose, and capable of keeping the displayed images colors as far as no energy is again imposed thereon” includes a medium causing different colors by the change of heating temperature, a medium causing different colors by the change of the strength of electric field, a medium causing different colors by the change of the strength of magnetic field, a medium causing different colors by the change of the strength and kind of laser beam irradiation. Among these, the medium causing different colors by the change of heating temperature is favorably used in the present invention, because it has advantages that the apparatus and device for treating it is simple, and cost for processing it, in other words recording and erasing the images to be displayed using it, is relatively low.

As specific examples of the medium causing different colors by the change of heating temperature include one type using a leuco dye together with a color-developer having long chain allyl group, and another type using liquid crystal material of compound having middle molecular weight.

The application of the medium of type using a leuco dye together with a color-developer having long chain alkyl group includes a case of the employment of the leuco dyes which are developed in different colors in piled up layers, and another case of the employment of the leuco dyes which are developed in different colors placed at the same extent but arrayed in divided sub-areas.

The mediums causing different colors by the change of the strength of magnetic field have in general an advantage that they show an excellent durability in the repeated use, therefore are favorably used in the present invention, and for example include a liquid crystal material having both-states-stability such as cholesteric liquid crystal material.

As also already mentioned above, the present invention provides at second an image-displaying method for displaying images onto a point card used for presenting a premium point to be exchanged to a corresponding premium feature to the customer in accordance to sales number of times, sales amount or sales volume, wherein the method uses the card which has a reversible color-recording medium at least a part therein and a memory for information storage, and the recording medium is capable of forming and erasing images of at least one color of a plural of colors upon energy impose, and capable of keeping the displayed images colors as far as no energy is again imposed thereon, and when the accumulated points being displayed on the card come up to or exceed a previously determined numerical worth value, at least one color of at least one image in displayed images or a color of background area thereof is changed and at the same time the stored information in the memory is updated as acquired or spent by the customer.

Hereupon, examples of “the memory for information storage” include magnetic memory, IC, non-contact type IC.

Examples of “the recording medium capable of forming and erasing images of at least one color in a plural of colors upon energy impose, and capable of keeping the displayed images colors as far as no energy is again imposed thereon” include the same ones as mentioned above in the first invention.

In case of the first and second image-displaying methods, a medium causing the change in the displayed image or color thereof or of background area when a predetermined valid term of the card is expired or a designated valid time of period is passed, is favorable. And a medium causing the change in the displayed image or color thereof or of background area, depending upon information of ID (Identification Data) of the card owner data, is favorable too.

As also already mentioned above, the present invention provides at third, a point card used for presenting a premium point to be exchanged to a corresponding premium feature to the customer in accordance to sales number of times, sales amount or sales volume, wherein the card has a reversible color-recording medium at least a part therein, and the recording medium is capable of forming and erasing images of at least one color in a plural of colors upon energy impose, and capable of keeping the displayed images colors as far as no energy is again imposed thereon, and when the accumulated points being displayed on the card come up to or exceed a previously determined numerical worth value, at least one color of at least one image in displayed images or a color of background area thereof is changed.

Examples of “the reversible color-recording medium capable of forming and erasing images of at least one color in a plural of colors upon energy impose, and capable of keeping the displayed images colors as far as no energy is again imposed thereon” include the same ones as mentioned above in the first invention.

Also, formation and erasing of images and color changes in the image and background area in this point card are similar as that of the first invention of the image-displaying method.

As also already mentioned above, the present invention provides at forth, a point card used for presenting a premium point to be exchanged to a corresponding premium feature to the customer in accordance to sales number of times, sales amount or sales volume, wherein the card has a reversible color-recording medium at least a part therein and a memory for information storage, and the recording medium is capable of forming and erasing images of at least one color in a plural of colors upon energy impose, and capable of keeping the displayed images colors as far as no energy is again imposed thereon, and when the accumulated points being displayed on the card come up to or exceed a previously determined numerical worth value, at least one color of at least one image in displayed images or a color of background area thereof is changed and at the same time the stored information in the memory is updated as acquired or spent by the customer.

Examples of “the reversible color-recording medium capable of forming and erasing images of at least one color in a plural of colors upon energy impose, and capable of keeping the displayed images colors as far as no energy is again imposed thereon” include the same ones as mentioned above in the first invention.

Also, formation and erasing of images and color changes in the image and background area in this point card are similar as that of the first invention of the image-displaying method.

As for the point cards of the third and forth inventions, favorable ones are a medium causing the change in the displayed image or color thereof or of background area when a predetermined valid term of the card is expired or a designated valid time of period is passed.

And a medium causing the change in the displayed image or color thereof or of background area, depending upon information of ID (Identification Data) of the card owner data, is favorable too.

The premium point described here can be one which is decided in accordance to sales number (it means purchases number with customer) of times, sales amount or sales volume, while the point can include one which is for example, sum of sales amount and sales number of times, and the like.

With regard to tie meaning of “previously determined numerical worth value” in case of “when the accumulated points being displayed on the card comes up to or exceed a previously determined numerical worth value”, this value can be figures showing the prices of exchangeable commodities or premium points corresponding to gift certificates or money values in gift certificates, or figures showing discounted prices or money values of these exchangeable commodities or gift certificates in which the discounts can be determined by a subtraction of a fixed amount, by a division of a fixed rate, by a multiplication of sales number of times, by a multiplication of sales frequency within determined period, by a multiplication of sales amount, and the like.

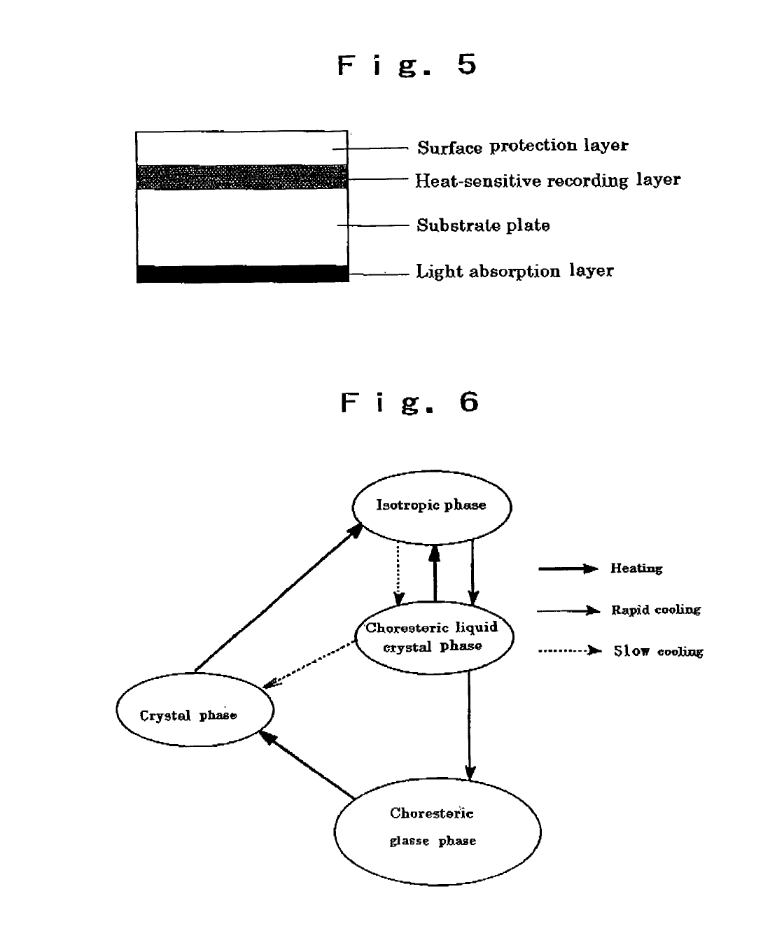

Color reversible recording material in the present invention may include materials such as thermo-chromisum material, electro-chromisum material, photo-chromisum material which are changeable in color by stimulating with applications of heat, electric field, light emission. And reversible heat-sensitive color recording material, for instance, reversible heat color-developable composition disclosed in Japanese Unexamined Patent Publication of Tokkai Hei 5-124360 which is one using a leuco dye together with an electron-donating compound having long chain aliphatic group of twelve or more carbon atoms, can be included. According to the disclosures of this patent literature, this color recording material can change color tone thereof by substituting the kind of dye used, and can shift color-developing temperature and discoloring temperature thereof by varying the long chain aliphatic group of the electron-donating compound, therefore reversible heat-sensitive color-developable sheet of multicolor can be prepared using this recording material. FIG. 5 in this patent literature is an example of reversible heat color-developing sheet showing an image of stripes which are two kinds of color stripes placed alternatively, and FIG. 6 in this patent literature is an example of reversible heat color-developing sheet showing an image of stripes which are three kinds of color stripes placed one another.

Further, material such as cholesteric liquid crystal which is reversibly changeable to plural states by stimulations, and is capable of reflecting lights of different wavelengths selectively in correspondence to the states, is effective material in the present invention because it enables itself multi-color display.

The card writer for rewritable use in the present invention can be one supplying a stimulation such as heat, electric field, light to the display material, like thermal head, electrode, laser.

With regard to the recording material of chorestric liquid crystal, a kind of recording materials consisting of a chorestric crystal compound having a molecular weight of 2000 or less and a glass transition temperature of 35° C. or more, or a material containing such chorestric crystal compound, are known as a recording material which causes colored states with selective light reflections, made by quick cooling from its chorestric crystal phase, and these colored states can be held for a long time of period at room temperature, on the other hand if this chorestric crystal compound is heated again to return to the liquid crystal state, repeatable write-in actions are possible with this recording matrial, therefore this recording material of the chorestric crystal makes itself possible to apply for rewritable full color recording and for multi-value light recording media (N. Tamaoki, A. V. Parenov, A. Masaki, H. Matsuda, Adv. Mater. 1997. 9. pp 1102-1104).

We, the inventors have proposed by Japanese Unexamined Patent Publication of Tokkai 2000-251317 a reversible recording medium having an improved whiteness using diffuse light and comprising a recording layer formed by using a chorestric liquid crystal material, and a recording method using this reversible recording medium. This reversible recording medium is one comprising a thermosensitive recording material including a chorestric liquid crystal compound or a mature of the chorestric liquid crystal compound with other ingredients, and this recording medium has a thermosensitive recording layer, a light absorption layer and one or more transparent layers which are positioned between the thermosensitive recording layer and the light absorption layer, wherein the thermosensitive recording layer is one capable of demonstrating a white display state caused by steps of temperature-rising at least an area of the recording layer surface to the temperature level to form isotropic phase or liquid crystal phase at elevated temperatures, then cooling it to the level of glass transition point or room temperature, and the one or more transparent layers are ones constituted by transparent material having lower refraction index than that of said thermosensitive recording layer or other transparent material. And the proposed recording method is a recording method using this reversible recording medium.

On the other hand, there is proposed by Japanese Unexamined Patent Publication of Tokkai 2002-127486 an image recording method in Japanese Patent Application which is a color image recording method using a recording medium having a theremosensitive recording layer containing thermotropic liquid crystal compound capable of forming a chorestric liquid crystal phase, and the recording layer is positioned between two substrates, and out of the both substrates, at least one is transparent, and the recording method comprising steps of heating the thermosensitive layer to a temperature level to demonstrate its chorestric liquid crystal phase, then cooling it with a cooling velocity to a temperature level, thereby forming image demonstrating selectively reflected colors based upon a solidified glass phase of a spiral molecular disposition of cholesteric liquid crystal, wherein the method uses a thermal head which has heat generation body capable of selective heating, and energy imposed to the heat, generation body is changed, thereby peak wavelength of the reflected light from said chorestric glass phase is controlled.

As shown in FIG. 5, the heat-sensitive recording sheet containing such cholesteric liquid crystal layer has a heat-sensitive recording layer of thermotropic cholestric liquid crystal compound provided onto a substrate, a transparent protection layer provided on the recording layer, and a light absorption layer to make an easy recognition of the reflected color of chireteric phase, provided on the backside of the substrate. For the sake of improvements of the orientation for the liquid crystal and of adhesive in inter-layers, an under layer or an intermediate layer may be provided.

As the substrate plate, plastic films such as PET, PC, PES and the like films, laminated members thereof, glass plate can be employed. Although the substrate may be a rigid one, and there is probably no special limitation in its thickness, in case of the used for other display purposes, however in case of the present invention, the thickness of substrate is generally speaking, ranged in the scope of 50 to 500 μm, favorably 100 to 300 μm.

With regard to the surface protection layer, plastic films which have excellent transparency and excellent heat resistance such as PES, PEI are favorable, but the surface protection layer in the present invention is not restricted to these, and it can be provided by coating an UV-hardenable resin layer onto the formed recording layer, then curing the UV-hardenable resin layer. The thickness of the surface protection layer is favorably in the range of 1 to 30 μm. A thickness smaller than 1 μm causes an insufficient mechanical strength and causes a damage of the substrate, a thickness larger than 30 μm causes a degradation of efficiency of heat transmission to the heat-sensitive recording layer.

As for the light absorption layer for the purpose of visibility retention, black paint layer to be provided to the backside of the substrate, layer of black pigment having been dispersed in the substrate are included.

It is particularly favorable for the heat-sensitive recording layer in the present invention that cholesteric liquid crystal compounds having molecular weight in the range of 900 to 10,000, favorably 1000 to 2000 and having no distribution of molecular weights (middle molecular weight cholesteric liquid crystal), or mixture thereof, is used. And if melting points of the cholesteric liquid crystal compounds or the mixture thereof are observable, favorable ones are cholesteric liquid crystal compounds or mixture thereof which have glass transition temperature 30° C. or more.

FIG. 6 is a diagram showing a phase change model of a cholesteric liquid crystal compound material used in the point card of the present invention. Now referring the FIG. 6, when the cholesteric liquid crystal compound material is continuously heated from the crystal state, it causes an isotropic phase, then if it is cooled to the temperature level showing cholesteric liquid crystal phase gradually or quickly, the cholesteric liquid crystal compound material demonstrates selectively scattered colors corresponding to the temperatures. Hereupon, it is favorable to demonstrate cholesteric liquid crystal phase at a relatively high temperature of around 100 ° C. or more. And from this cholesteric liquid crystal phase, if it is gradually cooled to a level around room temperature, it crystallizes and causes milky state by light scattering. In this instance, if the recording layer is thin, there is a possibility to be observed as almost transparent. On the other hand, from this cholesteric liquid crystal phase, if it is quickly cooled to a level around room temperature, it causes a glassy solid with holding a spiral molecular disposition of cholesteric liquid crystal which demonstrates selective light scattered colors. Accordingly, by optional setting of the temperature or cooling speed and area to be cooled in the heat-sensitive recording layer, the image demonstrating desired selective light scattered colors can be recorded reversibly.

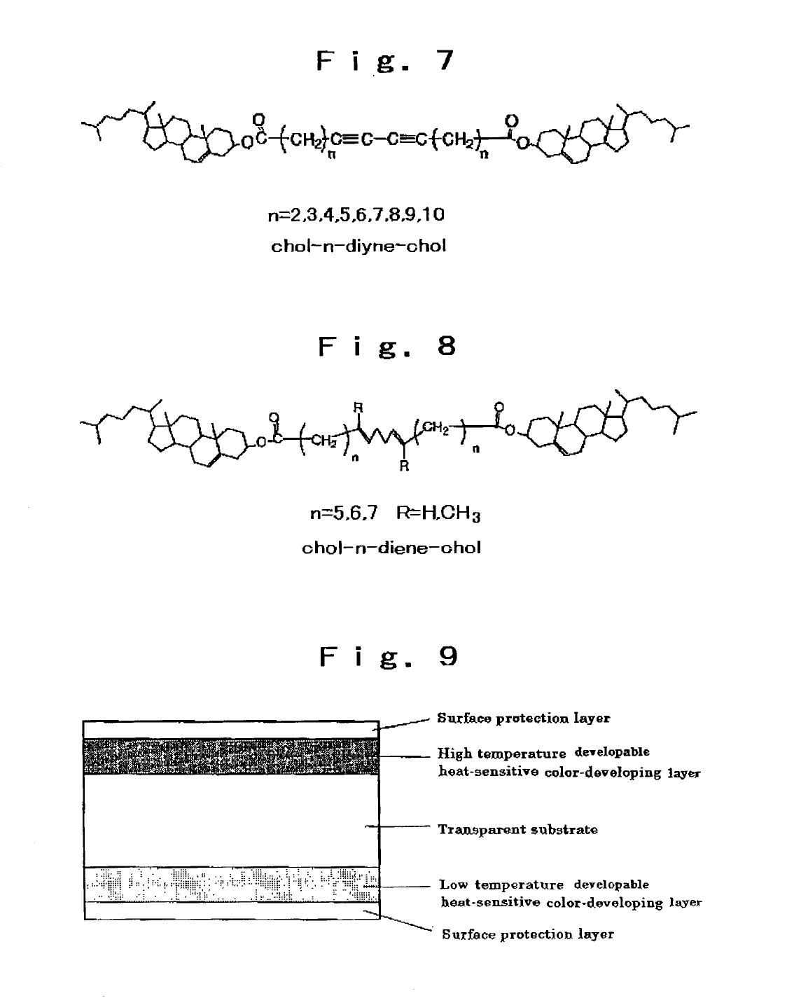

Cholesteric liquid crystal compounds having middle molecular weight which are used in the point card of the present invention are shown in FIGS. 7 and 8. However, cholesteric liquid crystal compound used in the present invention is not limited to the both compounds and any other is can be employed as far as it shows above mentioned recording characteristics of the glassy solid with holding a spiral molecular disposition of cholesteric liquid crystal demonstrating selective light scattered colors. The thickness of the recording layer ranges in the scope of 0.5 to 50 °μm, favorably 1 to 20 μm, therefore the recording layer may be selected so as to become thick in this range. The smaller thickness of the recording layer decreases the refraction index at wavelength capable of maximum light refraction, therefore causes a lowered contrast in displayed image. On the other hand, the larger excess thickness impedes a uniform heat transmission to the heat-sensitive recording layer, thus causes a degradation of color purity of the image, and causes an increase of light absorption at the heat-sensitive recording layer, causing a declined contrast of the image to be displayed. It is favorable in the present invention that the heat-sensitive recording layer is fabricated by only liquid crystal compounds demonstrating selective light refraction, however it may include a binder resin and spacer particles. Specific examples of the binder resin include polyvinyl chloride, polyvinyl acetic acid, epoxy resin, phenoxy resin, acrylic resin, polyurethane, polyester, and as for specific examples of the spacer particles, include ones being conventionally used for general liquid crystal display, and polymer dispersed type liquid crystal which is a liquid crystal material dispersed in a polymer material. The wavelength of light to be reflected selectively is favorably existed in the range of 400 to 700 nm which can visually recognize by human eye, but when read in using machine, device and instrument, the wavelength of selective reflection light may extend ultraviolet region or infrared region.

The rewriting mode of the present invention is one using a reversible image and another image, and either one thereof is used as a peculiar locked administration information for a valid term of the card or a designated valid time of period of the card, the owner name of the card and so forth, and another thereof is used as an information to be administrated. While among these two kinds of information it is possible to select either one side information is of formed by reversible color image and the remainder is said another image, here for convenience' sake, descriptions are advanced with a presumption that the information such as a preliminary determined valid term of the card or a designated valid time of period or the last valid date of the card and the owner name of the card and so forth is assumed as the administration information to administrate the another image, on the other hand information show an arrived instance date close to the invalid date in case of commuter pass, information showing total acquired points or acquired ratio at the instance time in case of point card for premium point given to the customer. However it is an expedient manner for simplifying for make understood the present invention, therefore said administration information is not restricted to the locked (fixed) information, and said information to be administrated by the administration information is not restricted to said changeable (unlocked) information, as obvious from description concludes Examples below.

(i) The Constitution Having Information Storage Part Other Than Image Recording Part in the Point Card

In case of this constitution, the point card of the present invention is further divided into (i-1) the constitution in which the information of said information storage part is possible to updating, and (i-2) the constitution in which the information of said information storage part is impossible to updating, and in case.

And in case of said (i-1), it is possible to record previously or to record using memory means of a card writer said fixed (locked) administration information of the card for examples time of period such as last valid date or updated date or name of owner of the card, and on the other hand to store the changeable (capable of updating) information to be administrated by said administration information in the remainder one of said image recording part or said another information storage part. There is an advantage in this (i-1) case that said locked administration information of the card can be revised pursuant to necessity. In the mean time, the card is inserted into a card reader-writer, and said locked administration information of the card is read-in to a card reader section of the card reader-writer, then the read-in administration information is collated to another administration information such as the last valid date which having been stored in the card reader-writer, to evaluate if the peculiar last valid time of the card is expired or not. And when the peculiar last valid time of the card is expired, the image or color of the image recording part is changed.

On the other hand in case of said (i-2), the image or color of the image-state information to be administrated positioned in the image recording part is changed pursuant to the administration information such as last valid date or date to be revised which having been recorded in a visual mode or in a machine-readable mode. Accordingly in this case, change of said administration information such as aforementioned fixed last date or date to be revised, however pursuant to the administration information, color or/and shape of the image in the image-recording part.

(ii) The Constitution Having No Information Storage Part Other Than Image Recording Part in the Point Card

In case of this constitution, the present invention can also be executed by (ii-1) the image recording part is divided into areas, to allocate one area of the areas to a recording part corresponding to the information recording part for said administration information or by (ii-2) an image processing apparatus such as card reader writer having an information memory as an auxiliary means is employed. In case of above mentioned (ii-1), not only color or image shape of changeable (capable of updating) information to be administrated can be revised pursuant to the administration information, but also the administration information its self can be updated, and in case of above mentioned (ii-2) too, if an information memory as an auxiliary means is one capable of updating, the administration information its self can be updated. For example, in the event of the reversible image recording card in the present invention is charged into the card reader writer, the state of the image recording part is read-in by the card reader part, information of peculiar time of period or limited date for the instance card is read out, by image analysis, then the read out information of peculiar time of period or limited date is collated. And if the collation result shows that the information of peculiar time of period or limited date for the instance card has been expired, color or image shape is changed by card writer part.

With regard to above mentioned cases, the manner of said (i) has an advantage that the card information is easily read, and the manner of said (ii) has an advantage that the card may be one having no information recording part, accordingly, either one is allowable. These both cases are ones in which a peculiar rewriting action is conducted for respective individual card, on the other hand in case of the same recording condition are applied for all cards, card reader is not required, colors or shapes of images of the all cards may be changed using a single date information stored in the card writer. Further, preset plural opportunities for rewriting are favorable due to causing an increase of information worth.

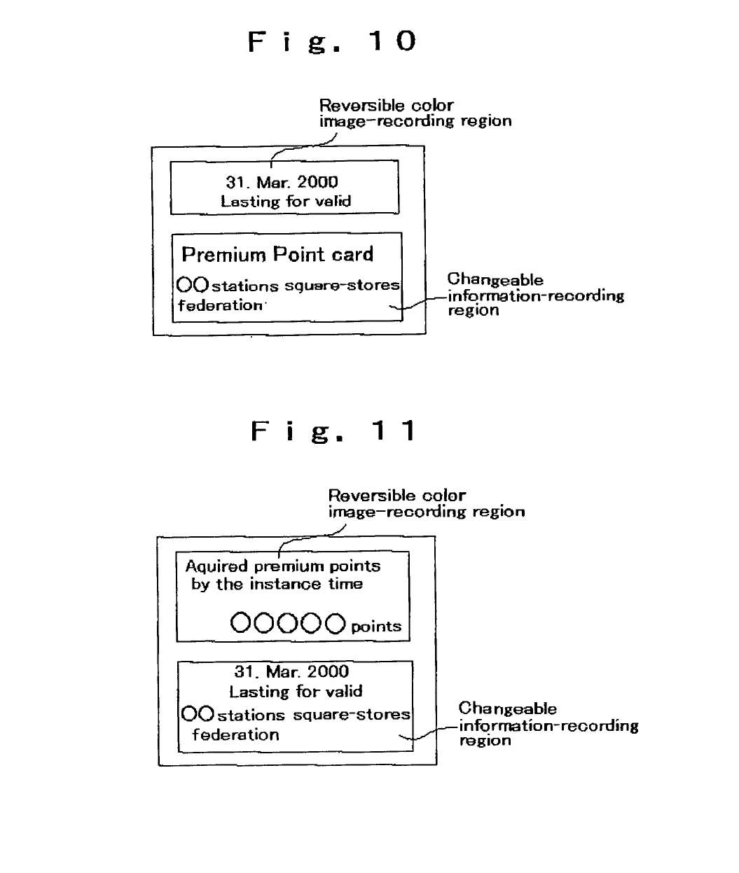

As shown in FIG. 9, in case of that the card of the present invention is a card using reversible heat-sensitive recording material disclosed in Japanese Unexamined Patent Publication of Tokkai Hei 5-124360 which is one using a leuco dye and together with an electron-donating compound having long chain aliphatic group of twelve or more carbon atoms together with a binder material, it can be a card in which a reversible heat-sensitive recording material layer developable at high temperature and another reversible heat-sensitive recording material layer developable at low temperature are provided on the both sides of a transparent substrate, immediately or through under coating layer(s), or, can be another card in which surface protection layers are further provided onto said both reversible heat-sensitive recording material layers developable at high temperature and low temperature, respectively.

Examples of the cards used in the present invention are shown in FIGS. 10, 11 and 12, 13. The card shown in FIG. 10 is characterized by an image recording part consisting of a reversible color recording material, and remainder information memory may be the same as that used in the popularized card at the present time. The image recording part is provided in a portion of the card in the shown in this Example, however the image recording part can be one provided in all of a surface of the card. Image recording part of the card in the shown in this Example records a reversible color image, and this reversible color image is one capable of forming, erasing and repeatable recording a plural of colors and/or shapes of image, namely capable of a plural of image revisions.

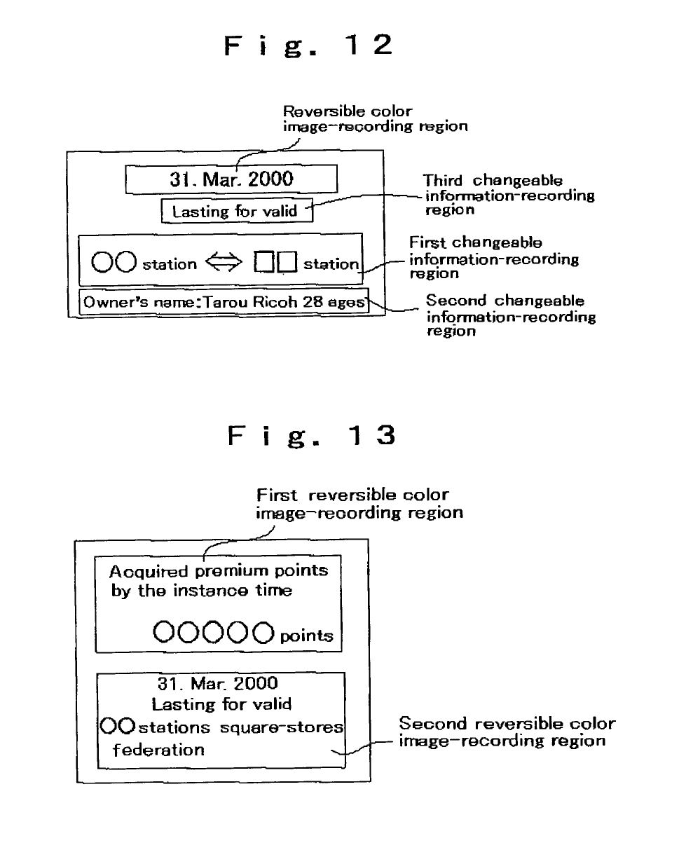

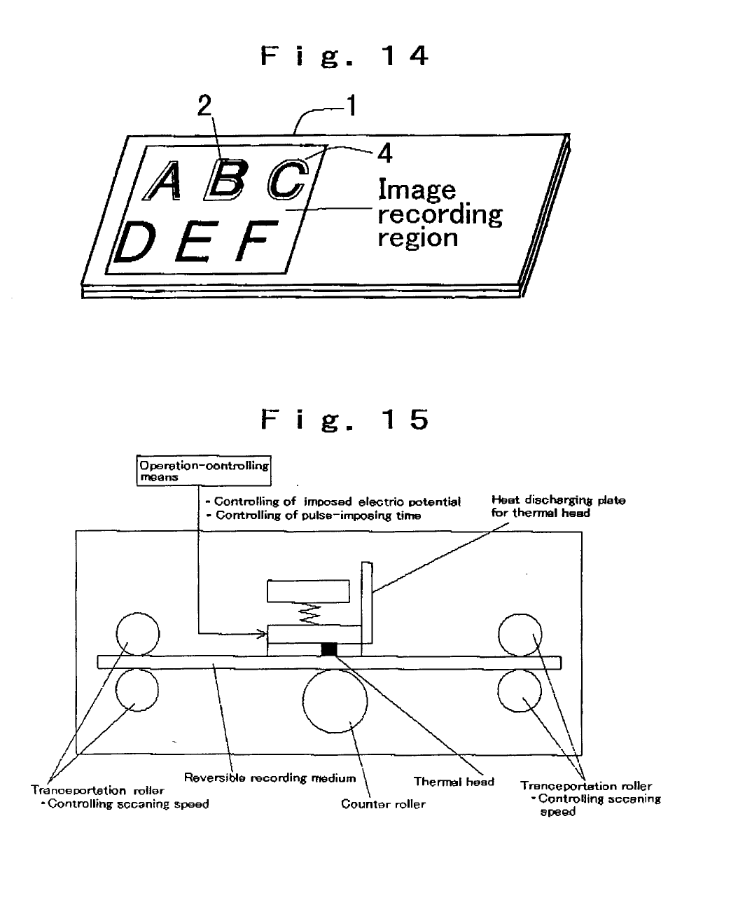

The card shown in FIG. 11 is an Example in which information of date or period is, as a fixed (locked) information, recorded in said administration information recording part, and changeable points are recorded in the reversible color image recording part. The card shown in FIG. 12 is an Example in which there are provided a reversible color image recording part (1) as one changeable image recording part, information memory part (2) for said another information, information memory part (3) for said another information. The card shown in FIG. 13 is an Example in which there are provided two reversible color image recording parts, non information memory part for said another information, namely, out of the two parts, one part is instead of the information memory part for said another information.

There are the cards causing particular effect by the present invention, these are classified mainly three kinds as denoted below.

(1) The cards relatively frequently used and having valid time of period for use;

such as commuter pass, premium point card, membership card, credit card and the like cards.

(2) The cards in which last valid date or valid time of period is provided and thereby is expected a prevention of wrong use;

such as commuter pass, highway toll ticket and the like ticket.

(3) The other cards frequently used;

such as ID card, cash card, point card, medical consultation card and the like card.

The card of the present invention corresponding to above class (1) has an important merit to impress so as to remark an important time schedule such as lasted valid date to the owner of the card. In case of card having a limited valid time of period, such period is demonstrated on the surface of the card in almost all cases, however many owners are always not heavily concerned because they are using it day-to-day, therefore they are accustomed to use it too much, and some eventual cases they meet an expired state of the limit valid date or just before state of expiring, with a careless oblivion of such last valid date. These incidents may be evaded by constructing a system which is changeable in image or color of the demonstrated last valid date in which the reversible information recording method of the present invention is used, and an outstanding color image being provided so as to attract attention of the owner and this image is revised using a card writer. Further the card having an updating time of period which being set in a prior term of the last valid date, allows to revise the last valid date with an enough time on hand in advance.

The card of the present invention corresponding to above class (2) has an important merit that it can evade a wrong use of it by imprinting times or dates with different colors by time section or by date section. A prevention method for steal ride in the train without paying for the middle of the journey of commuter is under trial at the present moment, by means of marking record a signal of passage time of a specified gate onto a magnetic recording stripe provided in the used commuter pass, using automatic ticket machine equipped with a magnetic recorder, said magnetic signal is not visual, therefore station employees and train crew member can not identify a commuter pass such wrong-used, with visual check. However such wrong-use of commuter pass becomes possible to identify with naked-eye, by displaying the passed time of commuter pass to the automatic ticket machine, onto the image recording part of the commuter pass surface, by using the reversible information recording method of the present invention, and equipping a card writer in the automatic ticket machine. And, obvious irregular image to be displayed on the commuter pass inserted into the automatic ticket machine by time section, for example by the mode of a displaying image on the commuter pass passed in a time section between 7:00 to 8:00 o'clock is red and a displaying image on the commuter pass passed in next time section between 8:00 to 9:00 o'clock is blue.

The card of the present invention corresponding to above class (3) has a significant merit that it is improved in designing appearance. Displaying of seasonable image in the turn period of the season makes the owner of the card comfortable. Optional revision and displaying of photograph of owners face in for example ID card gives a pleasure to exchange the photograph to favorite one of the owner, and an advantage to make accurate personal identification of owner, hence making of repeated use of the used card, resulting a high durability of the card.

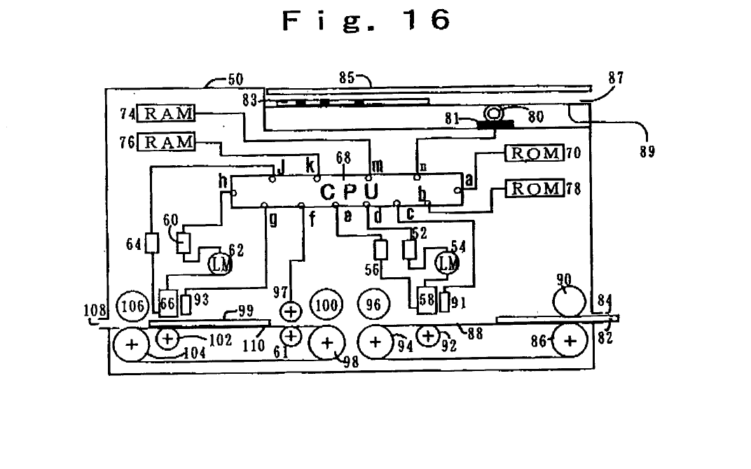

A conceptual Example of an apparatus for treating a point card of the present invention is shown in FIG. 15. In this apparatus a sheet shape recording medium is transported by transportation rollers as transportation means, then it is heated with a thermal head as heating means to make record the images. At this time the materials or substances as cooling means which contact with the recording medium being in the state of just after heated, such as for examples air, water, ice, metallic substances can be used, and further, device for cooling said materials or substances as secondary cooling means such as ventilation fan, Peltier element can be used. And this apparatus may equip with a pre-heater as heating means for preliminary heating the recording medium, an eraser means for discoloring the former image, in front of the thermal head. Further, while a thermal head is demonstrated in this FIG. 15, the apparatus for treating a point card of the present invention may have a plural of thermal heads, for example arrayed three thermal heads for writing-in red image, green image, blue image. And said transportation means may operate two rotation directions so that said recording medium is transported forwardly and backwardly, and a plural of treatments by the thermal head can be conducted.

The control of the energy to be imposed to the thermal head in the instance case may be carried out by any combination or by switching of each means, out of said all means, in accordance to characteristics of the recorded image and the required working efficiency.

In the card reader/writer and reversible information recording method of the present invention, the image region for forming reversible color image can be provided in an independently isolated mode from a region for administration information when said region for administration information having been existed. However when said region for administration information is different from said image region for forming reversible color image, the image region can be provided in overlapped location with the region for administration information. The image region for forming reversible color image may include a reversible image information such as date, premium point and other image information, and the image region can be provided on all surface of the card when the region for administration information is not existed. Further, this administration information may be a visual image information or a machine-readable image information when the administration information is a fixed (locked) information such as printed information. And also this administration information may be a machine-readable image information when it is an invisible but changeable information such as magnetically recorded information.

Accordingly, a region of said administration information consisting of the fixed image, can be used to determine a region of a reversible color image to be newly formed and to determine a shape of the reversible color image, in a manner in which the fixed image is monitored by a photo-sensor using CCD array to obtain an information regarding to the fixed image, then the obtained image information is reflected to determine an operation mode of thermal head to be actuated for determining a region of the new reversible color image to be formed and a shape of the new reversible color image. Otherwise, in case of a given information for forming a thermally transferred image is already existing, this memorized existing image information is directly used for determining an operating mode of a thermal head for revising the color and/or the shape of the reversible color image as an information to be administrated, so that the memorized existing image information is reflected to a operation mode of thermal head to be actuated for revising the region and the color/shape of the reversible image.

On the other hand, in case of reflecting said administration information as said fixed image to a operation mode of thermal head for forming a reversible color image as said information to be administrated, the region of said information to be administrated can provide in the same area as the region of said administration information but both image informations are formed so as to evade a mutual overlapping, however it is favorable to provide individual regions for the both image informations.

For example specifically, as shown in FIG. 14, a fixed image (2), which is for example a character or a pattern and the like printed on the card shape sheet (1), in the fixed image region (2) can be changed to a so-called enhanced character, by modifying with a changeable image which is provided in a region (4) therefor and positioned along with the outer fringe of said character.

An Example of an apparatus of a card reader writer for treating a point card of the present invention is shown in FIG. 16 which is drawn with some exaggeration for the aid of enough understanding of the apparatus and a recording method using it. In the card reader writer of FIG. 16, an information for an operation mode of the thermal head used for printing an administration information which being formed in advance, is recorded as a binary code data information consisting of a position information of pixels and a presence information of pixels. Then depending on the recorded binary code data of the fixed administration information, an image region which is one to be formed a reversible color image using a thermal head is decided, by steps comprising setting an image region by determining a image data to print the reversible color image using known digital image recognition method and known digital image processing method, for example such as an expanding technique of solid image and enlarging technique of image using a commercially available computer program for executing a window function method using a template means having 3×3 windows as digital filter, then with a use of the formed new image data of reversible color image, determining operation modes of a driving device of the thermal head and an energizing circuit for the thermal head. Above described fixed administration information is formed on the card shape sheet, by using an information of the operation mode of the thermal head which being obtained in the course for forming a thermally transferred image, by recording a light pattern reflected from original image irradiated by light scanning thereof.

As examples of reference books and documents with regard to such digital image recognition method and digital image processing method, there are mentioned N. Yagi, M. Inoue, M. Hayashi, E. Nakasu, K. Mitani, M. Okui, S. Suzuki, Y. Kanetugu “Practical Image Treatment For Learning with Computer Languge” (Jun. 8, 1996) Ohum Publish Co. Japan, H. Ozaki, Y. Taniguchi “Image Treatment—from basis to application—Second Edition” (Nov. 20, 1988) Kyoritu Publish. Co. Japan, Allen Gersho, Robert M. Gray, translated by S. Furui, S. Tazaki, H. Kotera, H. Watanabe, “Vector Quantization and Signal Compression” (Nov. 10, 1998) CORONA Publish. Co. Japan, N. Yagi, M. Inoue, M. Hayashi, M. Okui, S. Goushi, “Practical Projected Image Treatment For Learning with Computer Languge”, (Apr. 10, 1997) Ohum Publish. Co. Japan, which are meaning ones. As for particular ones regarding to pattern matching processing among image recognition methods, there are many processes described in Jorge L, C. Sanz & Anil, Jain, “Machine-Vision Techniquics for inspection of printed wires boards and thick-films circuids” Optical Society of American, Vol. 1-3, No. 9/September, 1986, pp 1465-1482, and as pattern matching technique (comparison technique) as an image recognition method, there are also included ones described in Joan Mandevile “Novel method for analysis of printed circuid Jargos” IBM J.Res.Develop., Vol. 29, No.1, January (1985), and Japanese Examined Patent Publication of Tokkou Hei 8-7155.

An example of the includes in housing (50) thereof a dual light sensor (80) placed in a state of traveling-free by the action of a light source-driving means (81) locating under a transparent plate (89) placed in the bottom of a ditch (87) for temporary receiving an image original (83), a secondary thermal head (66) which is positioned at a downstream side of first thermal head (58), a platen roller (92) being countered to the first thermal head (58), a platen roller (102) being countered to the secondary thermal head (66), a fist endless belt (88) which is one for transporting a sheet (82) and is being suspended between a first driven roller (94) and a first driving roller (86) which is driven by a transportation motor which is not shown in this drawing, a platen roller (90) forming a pair with the first driving roller (86), a platen roller (96) forming a pair with the first driven roller (94), a second endless belt (110) which is one for also transporting the sheet (82) and is being suspended between a second driven roller (104) and a second driving roller (98) which is driven by another transportation motor which is not shown m this drawing, a platen roller (100) forming a pair with the second driving roller (98), a platen roller (106) forming a pair with the second driven roller (104), a first sensor (91) for monitoring an administration information formed on the card shape sheet (82) transported to the position of the first thermal head (58), a second sensor (93) for monitoring a reversible color image region formed on the card shape sheet (82) transported to the position of the second thermal head (66), a CPU (68) which acts as a common brain of controllers (52) and (60), energizing circuits (56) and (64), a first ROM (70), a second ROM (78), a first RAM (74), a second RAM (76).

While the second thermal head (66) is placed in the same side as of the first, thermal head (58) in the exemplified card reader writer shown in this FIG. 16, the second thermal head (66) is placed in the opposite side of the first thermal head (58) in case of the card reader writer shown in FIG. 9.

As would be obvious by above description and FIG. 16, said controller has a CPU (68) connected with the first and second ROMs (70)(78) and the first and second RAMs (74)(76), and emits the command signals to the controlling devices, namely to the electrificating heat generation-controlling means (56) and (64) for controlling energizing mode of the first and second thermal heads (58) and (66), and to the actuator controllers (52) and (60) for controlling actuators (54) and (62) to drive the first and second thermal heads (58) and (66) such as for examples linear motor means.

The first thermal head (58) has a head core part having many fine locuses which are ones heat-generate by energizing through the first electrificating heat generation-controlling means (56). And driving mode of a motor (which is a step motor belong to digital motor) to guide the first thermal head (58) to the traversal directions, is controlled by the first thermal head drive controller (52). And also driving mode of another motor as transportation motor (which is also a digital motor in this card reader writer) to rotate the first driving roller (86) for causing a relative forward and backward movement actions of the first thermal head (58) against the sheet (82), is similarly controlled.

The second thermal head (66) also has a head core part having many fine locuses which are ones heat-generate by energizing through the second electrificating heat generation-controlling means (64). And driving mode of a motor (which is also a step motor belong to digital motor) to guide the second thermal head (66) to the traversal directions, is controlled by the second thermal head drive controller (60). And also driving mode of another motor as a transportation roller (which is also a digital motor in this card reader writer) to rotate the second driving roller (98) for causing a relative forward and backward movement actions of the second thermal head (66) against the sheet (82), is similarly controlled.

To the first thermal head drive controller (52), driving-control signal is input from output port (d) of CPU (68). And to the first electrificating heat generation-controlling means (56), energizing mode-control signal is input from output port (e) of CPU (68). Similarly, to the second thermal head drive controller (60), driving-control signal is input from output port (h) of CPU (68). And to the second electrificating heat generation-controlling means (64), energizing mode-control signal is input from output port (j) of CPU (68).

The first ROM (70) and the second ROM (78), pursuant to commands from CPU (68), out put each stored certain program such as sequential processing program and data such as digital image data to be calculated, through input-output ports (a) and (b) to the CPU (68) respectively, and the first RAM (74) and the second RAM (76), pursuant to commands from CPU (68), transfer code data, through input-output ports (m) and (k) from and to CPU (68). Namely pursuant to commands from CPU (68) the stored data therein are repeatedly output to the CPU (68) to provide them to calculations, and the stored data are repeatedly revised by the input data from the CPU (68) and the revised data are repeatedly stored therein.

The dual light sensor (80) has both light emission and receiving functions, and is driven by a light source driver (81) pursuant to the command signal sent through input-output port (n), and receives the optical information reflected from original image, and emits digital signal of the light image, to and from CPU (68) and image-bearing cards.

To be more tangible, the first ROM (70) is a memory storing a sequential program, and it may be a memory for one tip micro computer and memory equipped in personal computer. Therefore it is storing information concerned with input output sequence of signals in input-output ports (a) to (n) of CPU (68), calculation modes of many data (containing data of digital image) CPU (68), and calculation program of the data.

CPU (68), pursuant to programs stored in the first ROM (70), receives information signals from each ROM, each RAM, supplies the information signals to each RAM, and outputs control command signals to each controller.

The second ROM (78) is a program memory for storing an image-treating program in which image data to be treated may be included, and the image-treating program is used for calculating a drive-controlling information and an electrificating heat generation-controlling information for the first thermal head (58), pursuant to image information input from the dual light sensor (80) to CPU (68).

The first RAM (74) stores the drive-controlling information and the electrificating heat generation-controlling information for the first thermal head (58) in the mode capable of read-out, and stored information is repeatedly revised by the input information from the CPU (68) and the revised information is repeatedly stored therein.

The second RAM (76) stores the drive-controlling information and the electrificating heat generation-controlling information for the second thermal head (66) in the mode capable of read-out, and stored information is repeatedly revised by the input information from the CPU (68) and the revised information is repeatedly stored therein.

The optical information monitored by the optical sensor (80), as it is the drive-controlling information and the electrificating heat generation-controlling information for the first thermal head (58), or as another drive-controlling information and another electrificating heat generation-controlling information revised by calculation based on the both basic informations stored in the first RAM (74) using the image treatment program of the second ROM (78) for the first thermal head (58), are stored in the first RAM (74), in the state capable of read-out. When the card shape sheet (82) is inserted into an inlet (84) of the card reader writer and is sent to the position of the first thermal bead (58) by the first endless belt (88), the drive-controlling information and the electrificating heat generation-controlling information for the first thermal head (58) are output through CPU (68), as a result, a reversible thermosensitive color image is formed on the card (88) reflecting the original image in the original (83).

As next sequence, CPU (68), pursuant to the drive-controlling information and the electrificating heat generation-controlling information for the first thermal head (58) being stored in the first RAM (74) in the state capable of read-out, calculates the another drive-controlling information and the another electrificating heat generation-controlling information for the second thermal head (66), and the calculated results are stored in the second RAM (76) in a state capable of read-out. Accordingly, when the card shape sheet (82) is sent to the position of the second thermal head (66) by transportation with the second endless belt (110), the another drive-controlling information and the another electrificating heat generation-controlling information for the second thermal head (66) are output through CPU (68), as a result, another reversible thermosensitive color image is formed on the card (88), then the card having two kinds of reversible thermosensitive color images is delivered from outlet (108) to the outside of the card reader writer.

In this Example, sensor (91) monitors the arrival of the card shape sheet (82) to the position of first thermal head (58), thereby the thermal head is driven and electrificating heat generation thereof is conducted. And, sensor (93) monitors the arrival of the card shape sheet (99) to the next position of heating means for erasing image (97), thereby second thermal head (66) is driven and electrificating heat generation thereof is conducted. The heating means for erasing image (97) is rotated in synchronization with the movement of second endless belt (110) as far as card shape sheet (99) is in transposing, with regardless if it is in heat-generating or not. The control systems in this case are similar to that of other equipment for examples, by heat controls of the thermal heads with the first and second electrificating heat generation-controlling means (56) and (64), by the driving controls of the first and second linear motors (54) and (62) with the first and second thermal head drive controllers (52) and (60), or transportation motors for the first and second driving roller (86) and (98). Such control systems themselves are known as shown in for examples Japanese Unexamined Patent Publications of Tokkai Hei 9-1840 and Tokkai Hei 8-318634, therefore is thought unnecessary of specific description hence is omitted. Similarly, tenacious descriptions for control system of the dual light source (80), control systems of the first and second driving rollers (86) and (98), clock mechanism, data latch mechanism, shift resisters are omitted.

Further, to simplify the description and make easy to understand it, read only memory ROM is shown here as divided to first ROM (70) and second ROM (78), but it is obvious that as in usual use such division is not always required, and random access memory RAMs (74) and (76) of course may be combined one. And these memories may be positioned at outside of the card reader writer, and bus line connected with decoders capable of controlled sequential withdraw of information of course can also be employed sequential, instead of many input-equipped a keyboard as an information input means and projected image monitoring means such as Cathode-Ray Tube.

Further, to simplify the description and make easy to understand it, thermal head drive controller is shown here as divided to first drive controller (52) for first linear motor (54) and second drive controller (60) for second linear motor (62), but is obvious that as in usual use, but such division is not always required, and electrificating heat generation-controlling means is shown here as divided electrificating heat generation-controlling means (56) and (64), but such division is not always required too.

Further, thermal head is shown here as divided to first thwermal head (58) and second thermal head (66), but such division is not always required, and twice uses of one thermal head in of course possible, by using matrix type line heads, or by a controlled linear movement of thermal head assembly in machine directions in addition to guides of MD directions.

[The Performance of the Present Invention]

As having been obvious from above specified descriptions, the present invention provides an image displaying method and point card capable of solving drawbacks and problems in conventional technologies, and provides an image-displaying method and a point card which are capable of presenting a premium point to be exchanged to a corresponding premium feature to the customer, and as for the customer side, the method and the point card are ones capable of making known an adequate opportunity for getting premium feature such as daily necessities goods, therefore they do not make lose or make forget the opportunity to exchange to the real premium feature, and thereby apt to make rouse the eager buying intention, with diminishing undesirable states such as overlooking of opportunity to exchange to a real worth.

What is claimed is:

1. A method for displaying images onto a point card used for presenting a premium point to be exchanged to a corresponding premium feature to the customer in accordance to sales number of times, sales amount or sales volume, wherein the method uses the card which has a reversible color-recording medium at least a part therein, and the recording medium is capable of forming and erasing images of at least one color in a plural of colors upon energy impose, and capable of keeping the displayed images colors as far as no energy is again imposed thereon, and when the accumulated points being displayed on the card comes up to or exceed a previously determined numerical worth value, at least one color of at least one image in displayed images or a color of background area thereof is changed.

2. A method for displaying images onto a point card used for presenting a premium point to be exchanged to a corresponding premium feature to the customer in accordance to sales number of times, sales amount or sales volume, wherein the method uses the card which has a reversible color-recording medium at least a part therein and a memory for information storage, and the recording medium is capable of forming and erasing images of at least one color of a plural of colors upon energy impose, and capable of keeping the displayed images colors as far as no energy is again imposed thereon, and when the accumulated point being displayed on the card comes up to or exceeds a previously determined numerical worth value, at least one color of at least one image in displayed images or a color of background area thereof is changed and at the same time the stored information in the memory is updated as acquired or spent by the customer.

3. The method for displaying images according to claim 1, wherein above described at least one color of at least one image in displayed images or one color of background area thereof is also changed when a predetermined valid term of the card is expired or a designated valid time of period is passed.

4. The method for displaying images according to claim 1, wherein above described at least one color of at least one image in displayed images or one color of background area thereof is also changed when identification data of the card owner does not concord with input data for verification.

5. A point card used for presenting a premium point to be exchanged to a corresponding premium feature to the customer in accordance to sales number of times, sales amount or sales volume, wherein the card has a reversible color-recording medium at least a part therein, and the recording medium is capable of forming and erasing images of at least one color in a plural of colors upon energy impose, and capable of keeping the displayed images colors as far as no energy is again imposed thereon, and when the accumulated point being displayed on the card comes up to or exceeds a previously determined numerical worth value, at least one color of at least one image in displayed images or a color of background area thereof is changed.

6. A point card used for presenting a premium point to be exchanged to a corresponding premium feature to the customer in accordance to sales number of times, sales amount or sales volume, wherein the card has a reversible color-recording medium at least a part therein and a memory for information storage, and the recording medium is capable of forming and erasing images of at least one color in a plural of colors upon energy impose, and capable of keeping the displayed images colors as far as no energy is again imposed thereon, and when the accumulated point being displayed on the card comes up to or exceeds a previously determined numerical worth value, at least one color of at least one image in displayed images or a color of background area thereof is changed and at the same time the stored information in the memory is updated as acquired or spent by the customer.

7. The point card according to claim 5, wherein above described at least one color of at least one image in displayed images or one color of background area thereof is also changed when a predetermined valid term of the card is expired or a designated valid time of period is passed.

8. The point card according to claim 5, wherein above descried at least one color of at least one image in displayed images or one color of background area thereof is also changed when identification data for card owner does not concord with input data for verification.

9. An apparatus for treating a point card used for presenting a premium point to be exchanged to a corresponding premium feature to the customer in accordance to sales number of times, sales amount or sales volume, wherein the apparatus records and erases images on the card which has a reversible color-recording medium in at least a part therein, and the recording medium is one capable of forming and erasing at least one color image in a plural of color images upon energy impose and capable of keeping the displayed images colors as far as no energy is again imposed thereon, and the apparatus comprises a read-in means of management data which are time series ones concerned with history of the card, an energy-imposing means for imposing a thermal or optical energy onto the recording medium, a drive control means for controlling the driving state of the energy-imposing means, a power supply-controlling circuit for controlling the electrifying state supplied to the energy-imposing means, and the drive control means and the power supply-controlling circuit are controlled by input signals which are issued depending on an information for management.

10. An apparatus for treating a point card for presenting a premium point to be exchanged to a corresponding premium feature to the customer in accordance to sales number of times, sales amount or sales volume, wherein the apparatus records and erases images on the card which has a reversible color-recording medium in at least a part therein, and the recording medium is one capable of forming and erasing images of a plural of colors upon energy impose and capable of keeping the displayed images colors as far as no energy is again imposed thereon, and the apparatus comprises a management data-updating means for updating the management data which are time series ones concerned with history of the card and being stored in an information memory unit, an energy-imposing means for imposing a thermal or optical energy onto the recording medium, a drive control means for controlling the driving state of the energy-imposing means, a power supply-controlling circuit for controlling the electrifying state supplied to the energy-imposing means, and the drive control means and the power supply-controlling circuit are controlled by input signals which are issued depending on the management data.

11. The apparatus for treating a point card according to claim 9, wherein the energy-imposing means is a thermal energy-imposing means which is capable of both recording the reversible new color images and erasing the existed reversible color images.

12. The apparatus for treating a point card according to claim 11, wherein the thermal energy-imposing means is a thermal head.

13. The apparatus for treating a point card according to claim 11, wherein the thermal energy-imposing means is a thermal head and a heat roller which is positioned in front of the thermal head, and conducts the erasure of the reversible color images which being existed in the point card.

14. The apparatus for treating a point card according to claims 9 or 10, wherein the information for management is an image information to be recorded in an image-forming material which comprises a leuco dye and a color-developer having long chain alkyl group.

15. The apparatus for treating a point card according to claims 9 or 10, wherein the information for management is a light-reflective image information to be recorded in an image-forming material which comprises a middle-molecular-weight liquid crystal material.

16. The apparatus for treating a point card according to claims 9 or 10, wherein the information for management is one provided on a transparent substrate.

17. The apparatus for treating a point card according to claim 12, wherein the apparatus is one having a photo-sensor to read-in an image information.

18. The apparatus for treating a point card according to claims 9 or 10, wherein the apparatus is one having a first memory for storing the information for management in a mode capable of invocation, a second memory for storing in advance a standard information for management and a CPU, and it can conduct calculations including comparisons of the information for management with the standard information for management.

19. The apparatus for treating a point card according to claim 18, wherein the apparatus is one having a faculty to reinput a result of the calculations by the CPU into the first memory in a mode capable of invocation, to update said information for management.

20. The apparatus for treating a point card according to claim 12, wherein the apparatus is one having a transportation means of the image recording medium for transporting the medium to the thermal head and to the outside of the apparatus, a driver for driving the transportation means, and a controller for the driver.

21. The apparatus for treating a point card according to claims 18 or 19, wherein said CPU is one having at least two or more input-output ports which are ones for inputting and outputting information signals from and to two or more means among the photo-sensor, the first memory and the second memory, the controller for the driver for driving the transportation means, the power supply-controlling circuit and the thermal head drive-controlling means, and having a third memory which stores a sequence program to decide sequential order for inputting from and outputting to said means with said information signals.

22. The apparatus for treating a point card according to claims 9 or 10, wherein said information to be managed is an inspection result of medical examination, and said information data for management contains normal value data, outlier value data, caution value data, and colors of demonstrated information to be managed are differed according to said three value data.

23. The apparatus for treating a point card according to claims 9 or 10, wherein said information to be managed and/or said information for management include data showing time of period or data showing limit date.
